(19) United States
(12) Patent Application Publication
(10) Pub. No.: US 2025/0273857 A1
(43) Pub. Date: Aug. 28, 2025

(54) TRANSMITTING DEVICE, RECEIVING DEVICE, AND METHOD FOR DETERMINING A TRANSMITTING SUBARRAY

(71) Applicant: NTT DOCOMO, INC., Tokyo (JP)

(72) Inventors: Xiang Li, Beijing (CN); Xiaolin Hou, Beijing (CN); Xin Wang, Beijing (CN); Lan Chen, Beijing (CN); Satoshi Suyama, Tokyo (JP); Tatsuki Okuyama, Tokyo (JP)

(73) Assignee: NTT DOCOMO, INC., Tokyo (JP)

(21) Appl. No.: 18/857,975

(22) PCT Filed: Apr. 29, 2022
(86) PCT No.: PCT/CN2022/090279

§ 371 Date: Oct. 18, 2024

(51) Int. Cl. H01Q 3/36

(52) U.S. Cl. CPC H01Q 3/36

(57) ABSTRACT

Embodiments of the present disclosure provide a receiving device and a transmitting device and corresponding methods. A transmitting device according to embodiments of the present disclosure includes: a transmitting unit including a first antenna array; and a control unit configured to determine a second projection array of a receiving antenna array of a receiving device in a second affine subspace of a receiving device, to determine a first projection array of a second projection array in a first affine subspace of the transmitting device and to determine a transmitting subarray in the first antenna array according to information about an angle of departure of a signal of the transmitting device and the first projection array.

### TECHNICAL FIELD

The present disclosure relates to a field of wireless communication, and more particularly, to a transmitting device and a method for determining a transmitting subarray.

### BACKGROUND

In the 3GPP (3rd Generation Partnership Project), research is being conducted on a wireless communication method called NR (New Radio) or 5G in order to realize a further increase in a system capacity, a further increase in a data transmission speed, and a further increase in a low latency in a wireless zone. In order to meet the demand for a large throughput in a wireless communication system, it is necessary to consider using a large bandwidth provided by a high-frequency system and to fully utilize a spatial multiplexing gain of a multiple-input multiple-output (MIMO) technique, thereby enhancing a spectral efficiency (SE) by transmitting multiple streams of data at the same time.

However, a high-frequency system often needs to rely on a LOS path to ensure a signal strength. In a high-frequency LOS scenario, if an antenna array size is small, a LOS channel is only capable of transmitting a 1-stream signal. Even if the number of antenna units in the antenna array is increased, it is difficult to support a multi-stream transmission required by the MIMO technique.

### PRIOR ART DOCUMENTS

Non-patent document 1: P. Larsson, “Lattice array receiver and sender for spatially orthonormal MIMO communication”, IEEE 61st Vehicular Technology Conference. 2005, vol. 1, pp. 192-196.

### SUMMARY

### Problem to be Solved by the Invention

In a practical communication scenario, a receiving device may be located in an arbitrary direction of a transmitting device, and, for example, a receiving device of a user terminal may be held or placed at any angle, so that a receiving antenna array in the receiving device may be oriented in an arbitrary direction with respect to a transmitting antenna array in the transmitting device. Where the receiving device may be located in any direction of the transmitting device and the receiving array may be in any direction relative to the transmitting array, orthogonality of a plurality of channels between the transmitting antenna array and the receiving antenna array generally does not hold. When the orthogonality of the plurality of channels does not hold, data streams transmitted through respective channels interfere with each other. As a result, there are problems such as degradation of the performance of the communication system.

### Solution for Solving the Problem

According to an aspect of the present invention, there is provided a transmitting device comprising: a transmitting unit comprising a first antenna array; a control unit configured to determine a second projection array of a receiving antenna array of a receiving device in a second affine subspace, to determine a first projection array, corresponding to the second projection array, in a first affine subspace of the transmitting device and to determine, according to information about an angle of departure of a signal of the transmitting device and the first projection array, a transmitting subarray in the first antenna array.

### Effect of the Invention

According to embodiments, a method and a corresponding device as follows are provided which improve the orthogonality of the plurality of channels between the transmitting antenna array and the receiving antenna array. Thus, a plurality of data streams with a low mutual interference may be transmitted simultaneously, ensuring the performance of the communication system.

### BRIEF DESCRIPTION OF DRAWINGS

The above and other objects, features and advantages of the present disclosure will become more obvious by describing embodiments of the present disclosure in more detail in conjunction with accompanying drawings. The accompanying drawings are provided to provide a further understanding of the embodiments of the present disclosure, constitute a part of the specification, serve to explain the present disclosure together with the embodiments of the present disclosure, and do not constitute a limitation of the present disclosure. In the drawings, like reference numerals usually represent like components or steps.

FIG. 1 is a schematic diagram illustrating an example scenario of transmission using a high frequency band.

FIG. 2 is a schematic diagram illustrating an example scenario of transmission using a widely spaced array antenna.

FIG. 3 illustrates an equivalent channel diagram between a transmitting antenna and a receiving antenna shown in FIG. 2.

FIG. 4A-FIG. 4C are schematic diagrams illustrating a transmitting unit of a transmitting device, according to embodiments of the present disclosure.

FIG. 5A and FIG. 5B are schematic diagrams illustrating a number of scenarios in which an equation 1 applies.

FIG. 6 is a schematic diagram illustrating a scenario in which the equation 1 does not apply.

FIG. 7 illustrates an example of determination of a transmitting subarray, which is supported according to embodiments of the present disclosure.

FIG. 8 is a schematic diagram illustrating determination of a second projection array according to a receiving antenna array in the example shown in FIG. 7.

FIG. 9 is an example diagram illustrating determination of a first projection array according to the second projection array in the example shown in FIG. 7.

FIG. 10 is a schematic block diagram illustrating a transmitting device according to one embodiment of the present disclosure.

FIG. 11 is a schematic block diagram illustrating a receiving device according to one embodiment of the present disclosure.

FIG. 12 illustrates a flowchart of a method of determining a transmitting subarray performed by a transmitting device according to one embodiment of the present disclosure.

FIG. 13 illustrates a flowchart of a method of determining a projection of a receiving subarray performed by a receiving device according to one embodiment of the present disclosure.

FIG. 14 is a schematic diagram of a hardware structure of a device according to an embodiment of the present disclosure.

### DETAILED DESCRIPTION

In order to make the objects, technical solutions and advantages of the present disclosure more obvious, exemplary embodiments according to the present disclosure will be described in detail below with reference to the accompanying drawings. Like reference numerals refer to like elements throughout the drawings. It should be appreciated that the embodiments described herein are merely illustrative and should not be construed as limiting the scope of the present disclosure.

The transmitting device described in the present disclosure may be a base station or the transmitting device may include a base station and a relay device for relaying signals transmitted by the base station, and furthermore, the receiving device described in the present disclosure may be a terminal or the receiving device may include a terminal and a relay device for relaying signals to the terminal, and vice versa. In the following embodiments of the present disclosure, the description will be mainly based on an example that the transmitting device includes a base station and the receiving device includes a terminal. However, it should be understood that these examples may be applied to other variations of the transmitting device and the receiving device.

The terminals described in the present disclosure may include various types of terminals, for example a vehicle terminal, a user equipment (UE), a mobile terminal (or called a mobile station), or a fixed terminal and so on. The base station (BS: Base Station) described in the present disclosure includes various types of base stations, for example a wireless base station, a fixed station, a NodeB, an eNodeB (eNB), a gNodeB (gNB), an access point, a transmission point (TP), a reception point (RP), a transmission/reception point (TRP), and so on.

In order to meet the demand for a large throughput in a future communication systems, it is necessary to consider the use of a large bandwidth provided by a high frequency band. For example, the use of the Asia-Pacific Hertz spectrum above 100 GHz needs to be considered. And a high-frequency system often relies on a LOS transmission to guarantee a received signal strength. FIG. 1 is a schematic diagram illustrating an example scenario of using a high frequency band for a LOS transmission. As shown in FIG. 1, when the high frequency band is used for the LOS transmission, there is a robust LOS path and a robust ground reflection path, while other reflection paths or scattering paths are weak.

On the other hand, in order to meet the demand for a large throughput in the future communication system, it is also desirable to fully utilize the MIMO spatial multiplexing gain to enhance the SE. As shown in FIG. 1, it is difficult to support multi-stream transmission due to the large number of channel conditions in the high-frequency band, where only robust LOS paths and robust ground reflection paths exist.

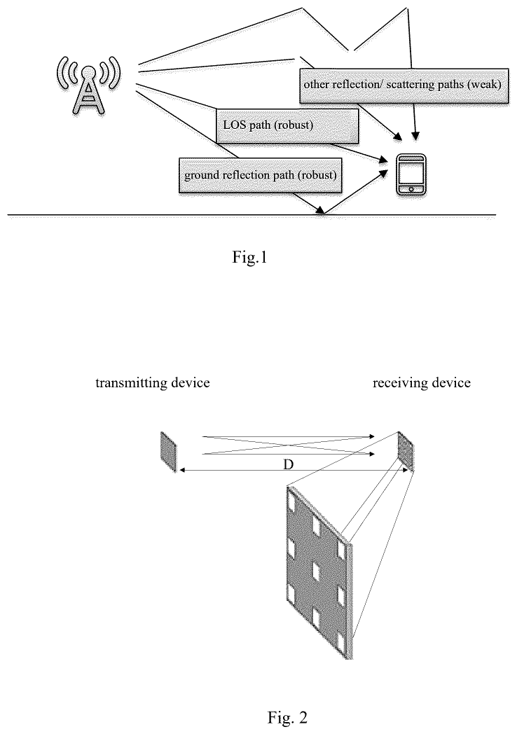

Therefore, it is proposed to improve the channel condition by improving the arrangement of the antennas. For example, the rank of the LOS channel may be increased by increasing the distance between the transmitting antennas in the antenna array of the transmitting device and the distance between the receiving antennas in the antenna array of the receiving device, so as to perform multi-stream transmission between a plurality of the transmitting and receiving antenna array pairs. FIG. 2 is a schematic diagram illustrating an example scenario of transmission using a widely spaced array antenna. In the example shown in FIG. 2, an array antenna arrangement of the receiving device has been described as an example for simplicity, and it should be understood that an array antenna arrangement similar to that of the receiving device is also required at the transmitting device. As shown in FIG. 2, the gray area 210 is an area where the plurality of array antennas of the receiving device are located, and each white square in the gray area 210 is a receiving antenna. The receiving antenna represented by each white square may be an array antenna, which may be referred to as a receiving subarray in this disclosure. Accordingly, one transmitting antenna in the transmitting device may also be an array antenna, which may be referred to as a transmitting subarray in this disclosure. Increasing the distance between the respective white squares so that it is much larger than the half-wavelength of the beam used by the communication system, thereby increasing a rank of the LOS channel or decreasing the number of the conditions of the LOS channel to allow for multi-stream transmission among the plurality of the transmitting and receiving antenna array pairs. In the present disclosure, the number of the conditions of the LOS channel may be a ratio of the maximum and minimum eigenvalues of the channel matrix. With a certain channel power and full rank, a smaller condition number is more favorable for multi-stream transmission.

Specifically, taking the uniform line array as an example, the optimal distance between respective neighboring transmitting and receiving antennas may be determined according to the following equation 1:

$${d}_{T} \cdot {d}_{R} = \frac{λ D}{N} \qquad ( 1 )$$

where d_{T} is a distance between the transmitting antennas, d_{T} is a distance between the receiving antennas, λ is a wavelength of a carrier used in the communication system, D is a distance between the transmitting device and the receiving device, and N is the number of the transmitting and receiving antenna pairs.

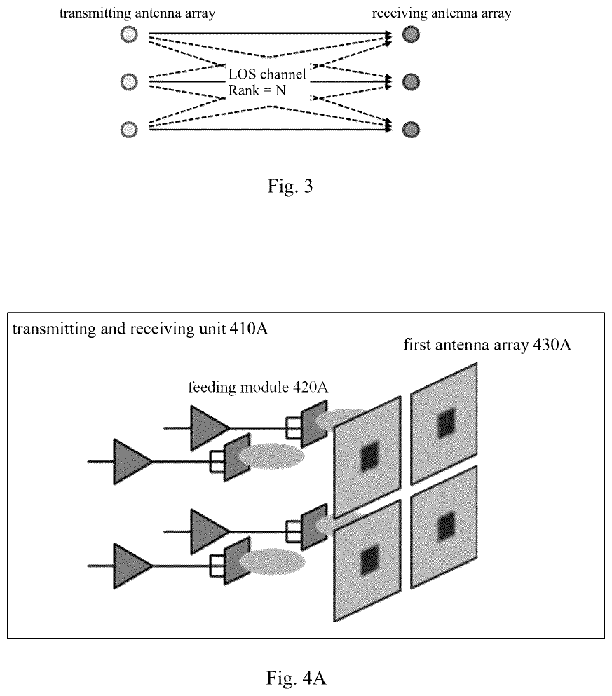

FIG. 3 is an illustration of an equivalent channel diagram between the transmitting antennas and the receiving antennas shown in FIG. 2 in an ideal case when the distance between the transmitting antennas and the distance between the receiving antennas in FIG. 2 are the optimal distances determined according to the equation 1. As shown in FIG. 3, in the LOS scenario, when the distance between the transmitting antennas and the distance between the receiving antennas are the optimal distances d_{T} and d_{R}, respectively, determined according to the equation 1, the channel between the transmitting antennas and the receiving antennas as shown in FIG. 2 may have a rank of 3, i.e., the number of transmitting and receiving antenna pairs N.

As shown in the equation 1, the optimal distance between the transmitting antennas or the optimal distance between the receiving antennas is related to the distance between the transmitting device and the receiving device. And when the optimal distance between the transmitting antennas or the optimal distance between the receiving antennas as shown in the equation 1 cannot be satisfied, the performance decreases significantly and it is difficult to achieve the expected gain.

In order to be able to adjust the antenna array according to the distance between the transmitting device and the receiving device to obtain the optimal distance between the transmitting antennas corresponding to the optimal distance between the particular receiving antennas, in an example according to the present disclosure, the transmitting unit of the transmitting device may comprise a first antenna array capable of flexibly controlling the subarray therein to be turned on or off. For example, the first antenna array may be a Reconfigurable Intelligent Surface (RIS). For another example, the first antenna array may be a phased array antenna (PAA). As another example, the first antenna array may be a lens array antenna. Optionally, the first antenna array may be divided into a plurality of first subarrays. Each first subarray may include one or more array elements. As described above, according to one example of the present disclosure, the transmitting device may be a base station, and the first antenna array may be a component included in the base station. Alternatively, the first antenna array may be provided independently of the base station. Additionally, the transmitting device may be a terminal device, and the first antenna array may be a component included in the terminal. Alternatively, the first antenna array may be provided independently of the terminal device.

The subarray in the first antenna array may be flexibly controlled to be turned on or off according to the distance between the transmitting device and the receiving device in any possible way to adjust the distance between the transmitting subarrays that are actually used for data transmission with the receiving device. For example, the transmitting unit may further include a feeding module for feeding the first antenna array. The feeding module may include a plurality of feeding submodules corresponding to a plurality of first subarrays, respectively. Optionally, when it is determined that the communication channel satisfies a predetermined channel condition according to information regarding the strength of the LOS channel component in the communication channel, the first antenna array may be configured via the feeding module to adjust the distance between the transmitting subarrays that are actually used for data transmission with the receiving device, according to at least one of position information and pose information of the receiving device.

In an example according to the present disclosure, the feeding module may feed the first antenna array in a wireless or wired way. For example, the feeding module may include a driving component and a second antenna array, and feed the first antenna array by driving the second antenna array via the driving component to transmit a beam to the first antenna array. As another example, the feeding module may include a driving component and feed directly the first antenna array via the driving component.

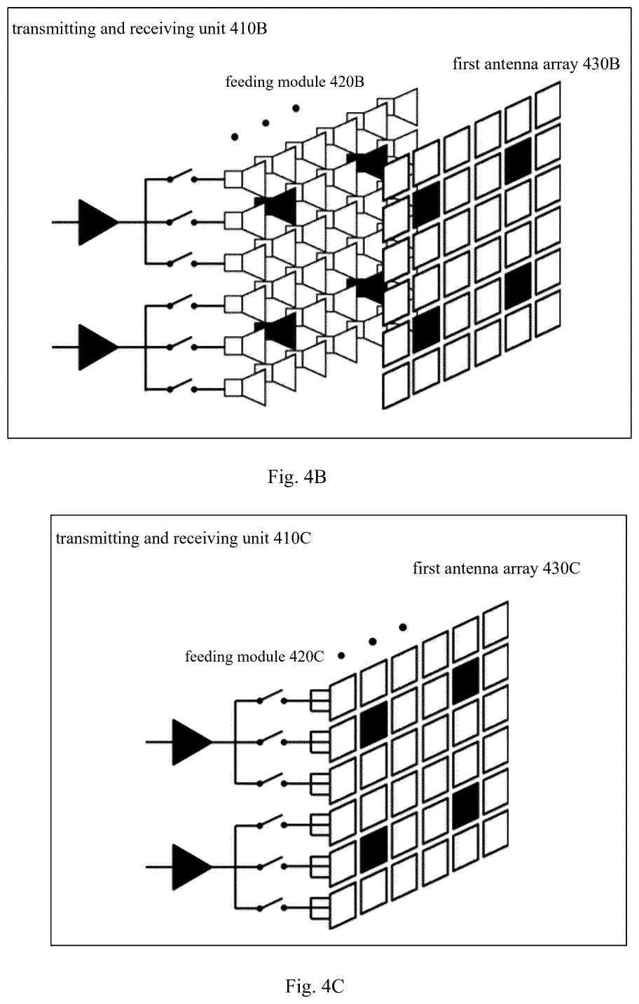

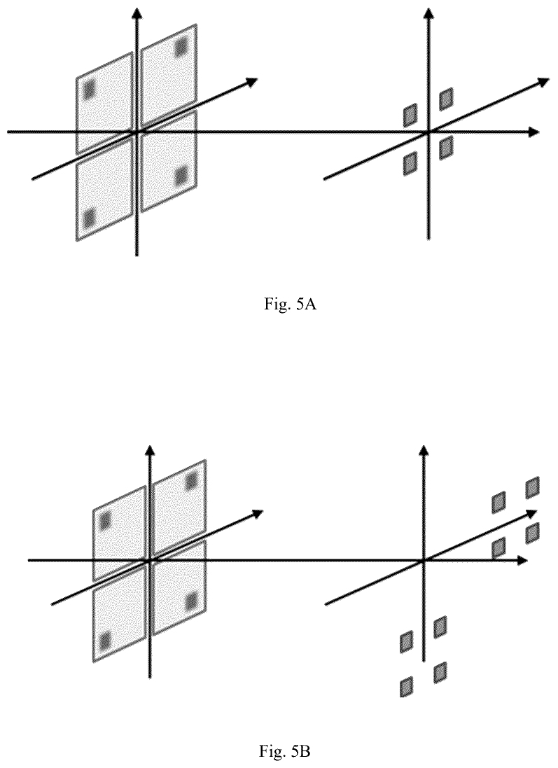

FIG. 4A-FIG. 4C are schematic diagrams illustrating a transmitting unit of a transmitting device, according to embodiments of the present disclosure. FIG. 4A is a schematic diagram illustrating a transmitting unit of a transmitting device, according to one embodiment of the present disclosure. In the example illustrated in FIG. 4A, the transmitting unit 410A includes a feeding module 420A and a first antenna array 430A, wherein the feeding module 420A includes a driving component (shown as a triangle in the feeding module 420A of FIG. 4A) and a second antenna array (shown as a square in the feeding module 420A of FIG. 4A). For example, the second antenna array may be a phased array antenna (PAA) or a lens array antenna. The first antenna array 430A is a RIS apparatus or a lens array antenna corresponding to the feeding module 420A. As shown in FIG. 4A, the first antenna array 430A is divided into four first subarrays, and the second antenna array includes second subarrays corresponding to the four first subarrays respectively, and the driving component is connected to each of the second subarrays respectively.

In the example shown in FIG. 4A, a second subarray connected to the driving component is driven by the driving component to transmit a second beam projected onto the corresponding first subarray. The black area in the first antenna array 430A of FIG. 4A schematically illustrates a spot formed on the first subarray by the main lobe of the second beam. The position of the second beam projected on the corresponding first subarray may be adjusted, for example, by beamforming the second beam transmitted by the second subarray. The first subarray may reflect or transmit the second beam projected onto the subarray to transmit the first beam.

In an embodiment according to the present disclosure, the array consisted of the array elements in the first subarray for transmitting the first beam may be referred to as a transmitting subarray. For example, in the example shown in FIG. 4A, in each of the first subarrays, the array elements in the region shown by the black square form a transmitting subarray. Each transmitting subarray may transmit one first beam.

In the example shown in FIG. 4A, it is described by taking an example that a second antenna array may be an antenna array capable of beamforming, for example, a PAA or a lens array antenna. Alternatively, the second antenna array may be a directional antenna. FIG. 4B is a schematic diagram illustrating a transmitting unit of a transmitting device, according to another embodiment of the present disclosure. In the example shown in FIG. 4B, the transmitting unit 410B of the transmitting device includes a feeding module 420B and a first antenna array 430B, wherein the feeding module 420B includes a driving component (shown as a triangle in the feeding module 420B of FIG. 4B) and a second antenna array (shown as a horn shape in the feeding module 420B of FIG. 4B). In FIG. 4B, the second antenna array may be a directional antenna array. The first antenna array 430B may be a RIS apparatus or a lens array antenna corresponding to the feeding module 420B. Since it is difficult for a directional antenna to change a direction of a beam transmitted therefrom by beamforming, a greater number of second subarrays are included for the second antenna array including the directional antenna than in the case where the second antenna array is an antenna array capable of beamforming. Furthermore, the first antenna array 430B may be divided into more first subarrays in order to correspond to the second subarrays. As shown in FIG. 4B, the second antenna array includes second subarrays corresponding to the plurality of first subarrays respectively, and the driving component is connected to each of the second subarrays respectively. In FIG. 4B, each horn-shaped marking represents a second subarray, and each second subarray may include one or more directional antennas.

Similar to FIG. 4A, in the example shown in FIG. 4B, a second subarray connected to the driving component is driven by the driving component to transmit a second beam projected onto a corresponding first subarray. The black area in the first antenna array 430B of FIG. 4B schematically illustrates the first subarray on which the main lobe of the second beam is located. A corresponding first subarray may be selected by driving a different second subarray. In the example shown in FIG. 4B, the first subarray corresponding to the second subarray that transmits the second beam is referred to as a transmitting subarray. Each transmitting subarray may transmit one first beam.

As above, the case of driving the first antenna array in a wireless feeding manner is exemplarily described in conjunction with FIGS. 4A and 4B. Alternatively, the first antenna array may also be driven in a wired feeding manner. FIG. 4C is a schematic diagram illustrating a transmitting unit of a transmitting device, according to another embodiment of the present disclosure. In the example shown in FIG. 4C, a transmitting unit 410C of the transmitting device includes a feeding module 420C, wherein the feeding module 420C includes a driving component (as shown by a triangle in the feeding module 420C of FIG. 4C). The first antenna array 430C is an antenna array corresponding to the feeding module 420C, for example a PAA. Since the wired feeding cannot change the direction of the beam transmitted therefrom by beamforming, the first antenna array 430C may be divided into more first subarrays for the case of the wired feeding than for the case in which the transceiver unit includes a second antenna array capable of beamforming. As shown in FIG. 4C, the driving component is connected to each of the first subarrays respectively to directly control to which first subarray the power is fed. The first subarray driven by the driving component (shown as black areas in the first antenna array 430C of FIG. 4C) may be referred to as a transmitting subarray. Each transmitting subarray may transmit one first beam. It should be understood that the black areas in FIG. 4A-FIG. 4C are illustrative only. According to the distance between the transmitting device and the receiving device, the location of the black area may change. Furthermore, the plurality of black regions in the first antenna array do not have to form a square. When the plane in which the transmitting antenna array is located is parallel to the plane in which the receiving antenna array is located (e.g., in the example shown in FIG. 2), the optimal distance between the transmitting antennas or the optimal distance between the receiving antennas may be determined for the rectangular antenna array according to the equation (1). For example, the equation 1 may be applied in both horizontal and vertical dimensions, thereby determining the distance between neighboring transmitting antennas or the optimal distance between neighboring receiving antennas in the rectangular antenna array. That is, the application of the equation 1 requires that the plane in which the transmitting antenna array is located be parallel to the plane in which the receiving antenna array is located. This means that when at least one of the transmitting antennas and the receiving antennas is an array antenna, the application of the equation 1 has requirements for the shape, orientation, and position of the array antennas in the transmitting antennas and the receiving antennas.

FIGS. 5A and 5B are schematic diagrams illustrating a number of example scenarios in which the equation 1 may be applied in both horizontal and vertical dimensions. In the example shown in FIGS. 5A and 5B, the transmitting device may include a first antenna array formed by the RIS apparatus 510. However, it should be understood that the transmitting unit of the transmitting device may also be formed in other ways as described, for example, above in conjunction with FIG. 4A-FIG. 4C. As shown in FIG. 5A and FIG. 5B, the first antenna array 510 is divided into four first subarrays. In each of the first subarrays, the array elements in the region shown by the black square constitute a transmitting subarray. Each transmitting subarray may transmit one first beam. The receiving device may include a receiving antenna array 520 formed by the plurality of receiving subarrays.

In the example shown in FIG. 5A, each subarray in the first antenna array 510 and the receiving antenna array 520 is rectangular. The plane in which the first antenna array 510 is located is parallel to the receiving antenna array 520, and the first antenna array 510 is coaxial with the receiving antenna array 520. In the example shown in FIG. 5B, each subarray in the first antenna array 510 and the receiving antenna array 520 is rectangular. The plane in which the first antenna array 510 is located is parallel to the receiving antenna array 520. Furthermore, although the first antenna array 510 is not on the same axis as the receiving antenna array 520, the receiving antenna array 520 is only translated in the x-axis or y-axis direction relative to the first antenna array 510.

In the example shown in FIGS. 5A and 5B, the plurality of subarrays of the first antenna array 510 and the receiving antenna array 520 are arranged in a rectangular shape, and the plane in which the first antenna array 510 is located is parallel to the receiving antenna array 520. In such a case, if an appropriate transmission beam is used, one receiving subarray may be at the center of the transmission beam, and the other receiving subarrays are at the zero point of the transmission beam. That is, the plurality of channels between the transmitting antenna array (i.e., the array formed by the transmitting subarrays used for transmitting in the first antenna array) and the receiving antenna array have orthogonality. Thus, for the examples shown in FIGS. 5A and 5B, it is appropriate to directly apply the equation (1) to both horizontal and vertical dimensions to determine the optimal transmitting antenna spacing.

However, the ideal case of a rectangular antenna array in which the plane in which the transmitting antenna array is located is parallel to the plane in which the receiving antenna array is located does not usually hold. The receiving device may be located in any direction of the transmitting device, and, for example, the receiving device of a user terminal may be held or placed at any angle, so that the receiving antenna array in the receiving device may be oriented in any direction relative to the transmitting antenna array in the transmitting device. At this point, it is difficult to ensure orthogonality of the channels between the transmitting antenna array and the receiving antenna array if the equation (1) is directly applied to the dimensions of both the horizontal and vertical directions to determine the horizontal and vertical spacings of the transmitting antennas, respectively.

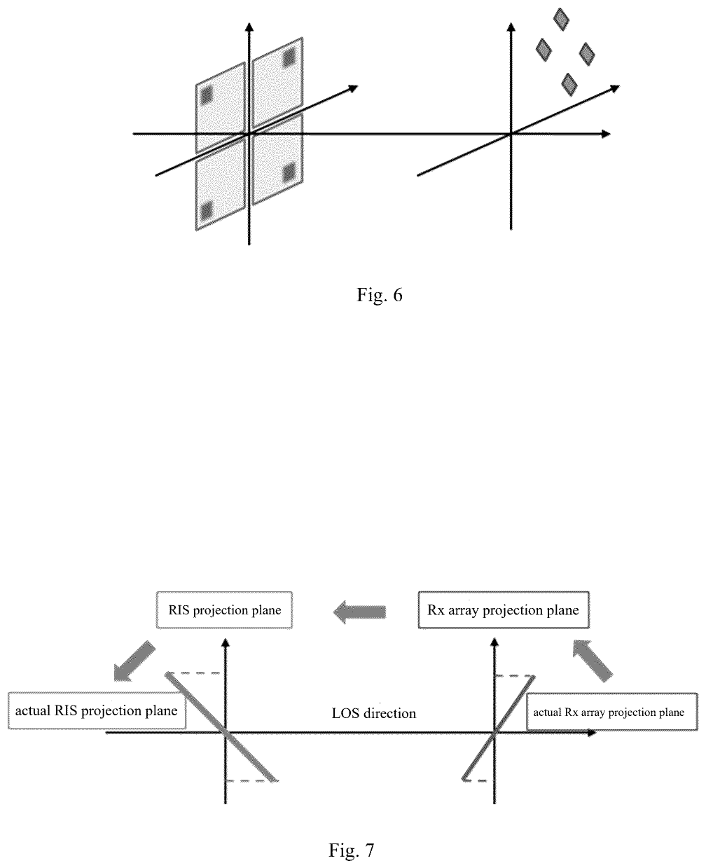

FIG. 6 is a schematic diagram illustrating an example scenario in which the equation 1 may not be directly applied in both horizontal and vertical dimensions. As shown in FIG. 6, the projection 620′ of the receiving antenna array of the receiving device on a plane parallel to the plane in which the first antenna array 610 is located is a parallelogram. This results in a plurality of channels between the transmitting antenna array and the receiving antenna array not being orthogonal. Thus, there are problems such as degradation of the performance of the communication system.

Embodiments according to the present disclosure provide the following method and corresponding device that improve the orthogonality of the plurality of channels between the transmitting antenna array and the receiving antenna array. Thus, a plurality of data streams with low mutual interference may be transmitted simultaneously, ensuring the performance of the communication system.

FIG. 7 illustrates an example of determination of a transmitting subarray, which is supported according to embodiments of the present disclosure. In the example shown in FIG. 7, the plane in which the receiving antenna array of the receiving device is located is not parallel to the plane in which the first antenna array of the transmitting device is located. In the case shown in FIG. 7, if the distance between the transmitting antennas is determined according to the distance between the transmitting device and the receiving device and the distance between the receiving antennas directly based on the application of the equation 1 above in both the horizontal and vertical directions, the respective data streams are not orthogonal to each other.

As shown in FIG. 7, in an embodiment according to the present disclosure, a transmitting subarray for data transmission with the indicated receiving device may be determined according to a pose of the receiving device and a pose of the transmitting device. A second projection array of the receiving antenna Rx array of the receiving device in a second affine subspace (which may also be referred to as an “Rx array projection plane” in the present disclosure) of the receiving device may first be determined. For example, an angle between the plane where the actual Rx array is located and the Rx array projection plane may be determined according to information about an angle of arrival (AoA) of the receiving device and information about a pose of the receiving device. For example, the information about the pose of the receiving device may include information about a rotation angle of the receiving device. In examples of the present disclosure, the rotation angle of the receiving device may be a rotation angle of the receiving device about the direction normal to the plane of the receiving array.

Then, a first projection array of the second projection array in a first affine subspace (which may also be referred to in this disclosure as a “Tx array projection plane”) of the transmitting device is determined. The transmitting device may perform an inverse transformation on the first projection array corresponding to the projection of the Rx array into the Rx array projection plane to inverse project the first projection array into the plane in which the first antenna array of the transmitting device is located so as to determine a transmitting subarray in the first antenna array for communication with the receiving device. An angle between the plane in which the first antenna array is located and Tx array projection plane may be determined according to angle of departure (AoD) information about the transmitting device.

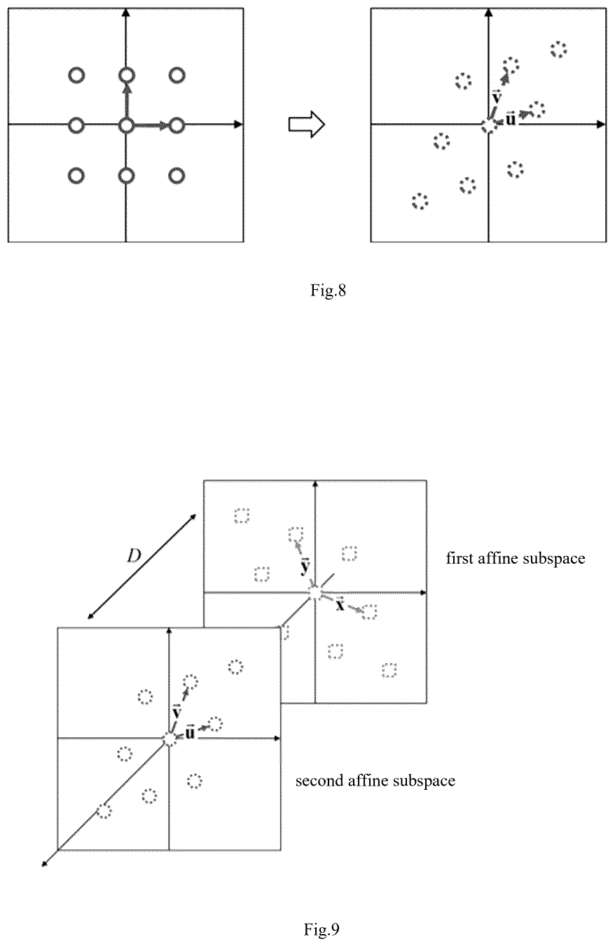

FIG. 8 is a schematic diagram illustrating determination of a second projection array according to the Rx array in the example shown in FIG. 7. As shown in FIG. 8, the actual receiving antenna Rx array of the receiving device is a rectangular array. In the example shown in FIGS. 8-9, each small circle represents a receiving antenna (or a receiving subarray) Rx or a transmitting antenna (or a transmitting subarray) Tx. A second projection array of the receiving antenna array in the second affine subspace may be determined according to information about the angle of arrival of signals at the receiving device and information about the pose of the receiving device. For example, a position of an antenna in the receiving antenna array may be determined according to the information about the angle of arrival of the signals at the receiving device and the information about the pose of the receiving device, and the receiving antenna array may be projected into the second affine subspace to obtain the second projection array. In the example shown in FIG. 8, the receiving antenna array is projected into the second affine subspace in an orthogonal projection manner according to the information about the angle of arrival of signals at the receiving device and the information about the pose of the receiving device. For example, the projection X′ᵢ of the ith antenna position y′ᵢ, in the second antenna array onto the second projection array may be represented as

$${x}_{i}^{′} = {A ( {A}^{T} A )}^{- 1} {A}^{T} {y}_{i}^{′} \qquad ( 2 )$$

wherein the column vectors of the matrix A may be a set of basis vectors of the second affine subspace that may be determined according to an angle of arrival (AoA) about the receiving device. In addition, according to one example of the present disclosure, an antenna position y′ᵢ in the second antenna array may be determined according to information about the receiving antenna array, an angle of arrival (AoA) about the receiving device, and a rotation angle about the receiving device. As shown in FIG. 8, after the orthogonal projection, the second projected array of the receiving antenna array in the second affine subspace is a parallelogram array. Alternatively, the receiving antenna array may be projected into the second affine subspace in other projection ways. For example, the receiving antenna array may be projected into the second affine subspace in a transmission projection way.

According to an example of the present disclosure, the shape of the Rx may be pre-set. For example, the Rx array may be defaulted to a rectangular array, a parallelogram, etc. Alternatively, the transmitting device may also determine the shape of the Rx according to information about the receive antenna array. Additionally, the transmitting device may also determine an arrangement of the Rx array according to information about the number and spacing of the receiving subarrays, and may determine a second projected array of the Rx array in the second affine subspace based on information about the pose of the receiving device according to the arrangement of the Rx array. For example, the receiving device may transmit information about the number and spacing of the receiving subarrays to the transmitting device. Alternatively, default values of the number and spacing of the receiving subarrays may be pre-set, such that the transmitting device determines the second projection array of the Rx array in the second affine subspace without receiving information about the number and spacing of the receiving subarrays.

FIG. 9 is an example diagram illustrating determination of a first projection array according to a second projection array in the example shown in FIG. 7. As described above, after determining the second projection array, a first projection array of that second projection array in a first affine subspace of the transmitting device may be determined according to the second projection array. As shown in FIG. 9, two adjacent edges of the parallelogram formed by the second projection array are v̅ and ū respectively, and two adjacent edges of the parallelogram formed by the first projection array are x and y respectively. Further, two adjacent edges of the parallelogram formed by the second projection array are perpendicular to two corresponding edges of the parallelogram formed by the second projection array. For example, in the example shown in FIG. 9, two adjacent edges v̅ and ū of the parallelogram formed by the second projection array are perpendicular to two adjacent edges x̅ and y̅ of the parallelogram formed by the first projection array, respectively. The above equation 1 is expanded with the edges of the parallelogram formed by the second projection array and the edges of the parallelogram formed by the first projection array to obtain the following equation 3:

$$〈 \vec{u} \cdot \vec{x} 〉 = \frac{λ D}{{N}_{H}} \qquad ( 3 )$$

$$〈 \vec{v} \cdot \vec{y} 〉 = \frac{λ D}{{N}_{V}}$$

$$〈 \vec{v} , \vec{x} 〉 = 0$$

$$〈 \vec{u} \cdot \vec{y} 〉 = 0 ,$$

wherein where λ is the wavelength of the carrier wave used by the communication system, D is the distance between the transmitting device and the receiving device, N_{H} is the number of antennas of the transmitting array along the direction \vec{X}, Nᵥ is the number of antennas of the transmitting array along the direction \vec{y}. The number of antennas of the transmitting array along the direction \vec{x} and the number of antennas of the transmitting array along the direction \vec{y} may be known for the transmitting device.

According to one example of the present disclosure, the transmitting device may determine a first projection array of the second projection array in a first affine subspace of the transmitting device according to information about a distance between the receiving device and the base station. For example, the transmitting device may determine a distance between the receiving device and the base station according to information about the location of the receiving device. For another example, the transmitting device may adjust the determination of the distance between the receiving device and the base station according to the position information of the receiving device to obtain a more accurate distance between the receiving device and the base station, according to information about one or more of an angle of arrival of a signal (e.g., an angle of arrival of a downlink signal), an angle of departure of a signal (e.g., an angle of departure of an uplink signal) at the receiving device, and a pose of the device, etc.

The transmitting device may then perform an inverse transformation on the first projection array corresponding to projection of the Rx array into the Rx array projection plane to inversely project the first projection array into the plane where the first antenna array of the transmitting device is located so as to determine a transmitting subarray in the first antenna array that is in communication with the receiving device. For example, the corresponding subarray position yᵢ in the first antenna array may be obtained from the ith projection xᵢ on the first projection array projected onto the first affine subspace by solving the following equation (4),

$$\{ \begin{matrix}{B ( {B}^{T} B )}^{- 1} {B}^{T} {y}_{i} = {x}_{i} \\ 〈 {y}_{i} , \vec{n} 〉 = 0\end{matrix} \qquad ( 4 )$$

where the column vectors of the matrix B are a set of basis vectors of the first affine subspace, which may be calculated according to information of the angle of departure (AoD) of the transmitting device; and \vec{n} denotes the normal direction of the first antenna array. Thereby, orthogonality of the plurality of channels between the transmitting and receiving arrays is ensured. Thus, multiple data streams with a low mutual interference may be transmitted simultaneously.

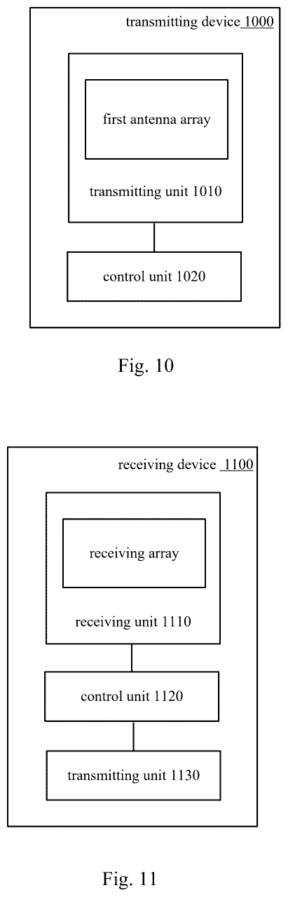

FIG. 10 is a schematic block diagram illustrating a transmitting device 1000 according to one embodiment of the present disclosure. As shown in FIG. 10, the transmitting device 1000 may include a transmitting unit 1010 and a control unit 1020. The transmitting device 1000 may also include other components, however, their illustrations and descriptions are omitted herein since these components are not relevant to the content of embodiments of the present disclosure.

The transmitting unit 1010 may include a first antenna array. For example, the transmitting unit and the first antenna array may be the transmitting unit and the first antenna array element described with reference to FIGS. 4A to 4C.

The control unit 1020 may determine a second projection array of the receiving antenna array of the receiving device in a second affine subspace of the receiving device. In some examples, the control unit 1020 may determine a second projection array of the receiving antenna array of the receiving device in the second affine subspace of the receiving device according to information about an angle of arrival of signals at the receiving device and information about a pose of the receiving device. Further, in some examples, the control unit 1020 may also determine the second projection array according to information about the number and spacing of antennas in the receiving array. For example, the control unit 1020 may perform an example of determining a second projection array of the receiving antenna array in the second affine subspace of the receiving device as described in conjunction with FIGS. 7 and 8.

Alternatively, a second projection array of the receiving antenna array in the second affine subspace of the receiving device may also be determined by the receiving device according to information about an angle of arrival of signals at the receiving device and information about the pose of the receiving device, and information about the second projection array may be transmitted to the transmitting device, as described below in conjunction with FIG. 11. The control unit 1020 may determine the second projection array according to the information about the second projection array received by the transmitting device.

The control unit 1020 may determine a first projection array of the second projection array in a first affine subspace of the transmitting device. In some examples, the control unit 1020 may determine a first projection array of the second projection array in a first affine subspace of the transmitting device according to information regarding a distance between the receiving device and the transmitting device. For example, the control unit 1020 may perform an example of determining a first projection array of the second projection array in the first affine subspace as described in conjunction with FIGS. 7 and 9.

The control unit 1020 may determine the transmitting subarray in the first antenna array according to information about the angle of departure of a signal of the transmitting device and the first projection array. In some examples, the information about the pose of the transmitting device includes information about the angle of departure of the transmitting device. For example, the control unit 1020 may perform an example of determining the transmitting subarray in the first antenna array as described in conjunction with FIG. 7.

### Alternative Example

FIG. 11 is a schematic block diagram illustrating a receiving device 1100 according to one embodiment of the present disclosure. As shown in FIG. 11, the receiving device 1100 may include a receiving unit 1110, a control unit 1120, and a transmitting unit 1130. The receiving device 1100 may also include other components, however, the illustrations and descriptions of which are omitted herein because they are not relevant to the content of embodiments of the present disclosure.

The receiving unit 1100 may include a receiving antenna array. The control unit 1120 may determine a second projection array of the receiving antenna array in a second affine subspace of the receiving device according to information about an angle of arrival of signals at the receiving device and information about a pose of the receiving device. For example, an example of determining a second projection array of the receiving antenna array in the second affine subspace of the receiving device as described in conjunction with FIGS. 7 and 8 may be performed by the receiving device.

The transmitting unit 1130 may then transmit information about the second projection array. In some examples, the information about the second projection array may include information about directions of two adjacent edges of a parallelogram formed by the second projection array and information about the distance between adjacent projection subarrays in the second projection array.

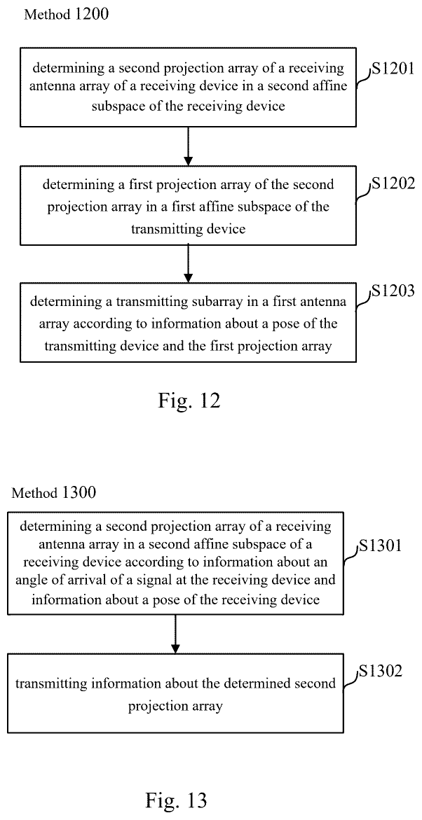

In the example shown in FIG. 11, only the information about the determined second projection array needs to be transmitted to the transmitting device without transmitting one or more of the information about the receiving antenna array, the information about the angle of arrival of signals, and the information about the rotation angle of the receiving device, thereby reducing a signaling overhead. In addition, by determining the second projection array by the receiving device according to the information about the angle of arrival of signals at the receiving device and the information about the rotational angular pose of the receiving device, the load of processing to be performed by the transmitting device is reduced. FIG. 12 illustrates a flowchart of a method 1200 of determining a transmitting subarray according to one embodiment of the present disclosure. In an example according to the present disclosure, the method 1200 of determining the transmitting subarray may be implemented by a transmitting device as described with reference to FIG. 10. In the following description for method 1200, certain operations performed by the transmitting device may be performed in a different order or at different times. Certain operations may also be omitted from the process method 1200, or other operations may be added to the method 1200.

In step S1201, a second projection array of the receiving antenna array of the receiving device in a second affine subspace of the receiving device is determined. In some examples, in step S1201, a second projection array of the receiving antenna array of the receiving device in the second affine subspace of the receiving device may be determined according to information about an angle of arrival of signals at the receiving device and information about a pose of the receiving device. Furthermore, in some examples, the second projection array may also be determined according to information about the number and spacing of antennas in the receiving array in step S1201. For example, an example of determining a second projection array of the receiving antenna array in the second affine subspace of the receiving device as described in conjunction with FIGS. 7 and 8 may be performed in step S1201.

Alternatively, a second projection array of the receiving antenna array in the second affine subspace of the receiving device may also be determined by the receiving device according to information about the angle of arrival of signals at the receiving device and information about the pose of the receiving device, and information about the second projection array may be transmitted to the transmitting device, as described below in conjunction with FIG. 13. In step S1201, the second projection array may be determined according to the information about the second projection array received by the transmitting device.

In step S1202, a first projection array of the second projection array in a first affine subspace of the transmitting device may be determined. In some examples, a first projection array of the second projection array in a first affine subspace of the transmitting device may be determined according to information about a distance between the receiving device and the transmitting device in step S1202. For example, an example of determining a first projection array of the second projection array in the first affine subspace as described in conjunction with FIGS. 7 and 9 may be performed in step S1202.

In step S1203, the transmitting subarray may be determined in the first antenna array according to information about the angle of departure of signals of the transmitting device and the first projection array. In some examples, the information about the pose of the transmitting device includes information about the angle of departure of the transmitting device. For example, in step S1203, an example of determining the transmitting subarray in the first antenna array as described in connection with FIG. 7 may be performed.

### Alternative Example

FIG. 13 illustrates a flowchart of a method 1300 of determining a projection of a receiving subarray performed by a receiving device according to one embodiment of the present disclosure. In an example according to the present disclosure, the method 1300 of determining a projection of a receiving subarray may be implemented by a receiving device as described with reference to FIG. 11, wherein the receiving device may include a receiving antenna array.

In step S1301, a second projection array of the receiving antenna array in a second affine subspace of the receiving device may be determined according to information about an angle of arrival of signals at the receiving device and information about a pose of the receiving device. For example, an example of determining a second projection array of the receiving antenna array in the second affine subspace of the receiving device as described in conjunction with FIGS. 7 and 8 may be performed in step S1301.

In step S1302, information about the determined second projection array may be transmitted to the transmitting device.

### <Hardware Structure>

In addition, block diagrams used in the description of the above embodiments illustrate blocks in units of functions. These functional blocks (structural blocks) may be implemented in arbitrary combination of at least one of hardware and software. Furthermore, a method for implementing respective functional blocks is not particularly limited. That is, the respective functional blocks may be implemented by one apparatus that is physically or logically jointed; or more than two apparatuses that are physically or logically separated may be directly and/or indirectly connected (e.g. wired and/or wirelessly) so that the respective functional blocks may be implemented by these several apparatuses. The functional blocks may also be implemented by combined software in the above one apparatus or the above several apparatuses.

Functionally, although there exists a judgment, a decision, a determination, a calculation, a computation, a processing, an export, an investigation, a search, a confirmation, a reception, a transmission, an output, an access, a solution, a selection, a choice, an establishment, a comparison, an envisioning, an anticipation, an opinion, a broadcasting, a notifying, a communicating, a forwarding, a configuring, a reconfiguring (reconfiguring), an allocating (mapping), an assigning and so on, but not limited to the above. For example, a functional block (structural unit) that enables transmission is called a transmitting unit or transmitter. All as described above, the method of realization is not particularly limited.

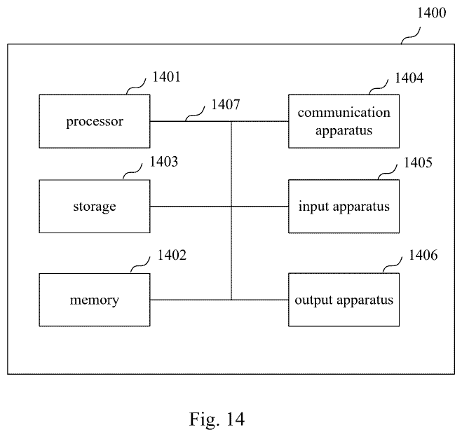

For example, a base station, a user terminal, and the like in one embodiment of the present disclosure may also function as a computer that performs a process of the wireless communication method of the present disclosure. FIG. 14 is a diagram showing one example of a hardware structure of a transmitting device and a receiving device involved in one embodiment of the present disclosure. The above-described transmitting device 1000 and receiving device 1200 may also be physically constituted as a computer apparatus comprising a processor 1401, a memory 1402, a storage 1403, a communication apparatus 1404, an input apparatus 1405, an output apparatus 1406, a bus 1407, and the like.

In addition, in the following description, the term “apparatus” can be replaced with a circuit, a device, a unit, etc. The hardware structures of the transmitting device 1000 and the receiving device 1200 may be composed of one or more of the illustrated apparatus, or may not be composed of some of the illustrated apparatus.

With respect to each function in the transmitting device 1000 and the receiving device 1200, it is realized by reading a specific software (program) into the hardware such as the processor 1401, the memory 1402, and the like, so that the processor 1401 performs calculations and controls the communication based on the communication apparatus 1404, or controls at least one of the reading out and writing of data in the memory 1402 and the storage 1403.

The processor 1401 controls the computer as a whole by, for example, enabling an operating system to operate. The processor 1401 may also be constituted by a central processing unit (CPU) containing an interface with a peripheral device, a control apparatus, an operation apparatus, a register, and the like. For example, the control unit 1020 of the above-mentioned transmitting device 1000 and the control unit 1120 of the above-mentioned receiving device, etc. may also be realized by the processor 1401.

In addition, the processor 1401 reads out a program (program code), a software module, data, etc., from at least one of the storage 1403 and the communication apparatus 1404 to the memory 1402, and performs various processes in accordance with them. As a program, a program that causes the computer to perform at least a portion of the operations illustrated in the above-described embodiment is used. For example, the control unit 1020 of the transmitting device 1000 and the control unit 1120 of the receiving device may also be realized by a control program that is stored to the memory 1402 and operated in the processor 1401, and the same may be realized with respect to other functional blocks. It is illustrated that the various processes described above are meant to be performed by one processor 1401, but they may also be performed by more than two processors 1401 simultaneously or sequentially. The processor 1401 may also be realized by more than one chip. Additionally, the program may be transmitted from a network via an electrical communication line.

The memory 1402 may also be a computer-readable recording medium, which is constituted by for example at least one of a ROM (Read Only Memory), an EPROM (Erasable Programmable ROM), an EEPROM (Electrically Erasable Programmable ROM), a RAM (Random Access Memory), and the like. The memory 1402 may also be referred to as a register, a cache, a main memory (main storage apparatus), and the like. The memory 1402 is capable of holding a program (program code), a software module, and the like that are executable for implementing the wireless communication method involved in an embodiment of the present disclosure.

The storage 1403 may also be a computer-readable recording medium which is constituted by for example at least one of an optical disc such as CD-ROM (Compact Disc ROM), a hard disk drive, a flex disk, an optical and magnetic disk (e.g., a compressed disk, a digital versatile disk, a Blu-ray (registered trademark) disk), a smart card, a flash memory (e.g., a card, a stick, a key drive), a floppy (registered trademark) disk, a stripe, and the like. The storage 1403 may also be referred to as an auxiliary storage apparatus. The recording medium described above may also be, for example, a database, server, other suitable medium comprising at least one of the memory 1402 and the storage 1403.

The communication apparatus 1404 is a hardware (transmitting-receiving device) for communication between computers via at least one of a wired network and a wireless network, for example also referred to as a network device, a network controller, a network card, a communication module, and the like. The communication apparatus 1404 may also be constituted to contain a high-frequency switch, a duplexer, a filter, a frequency synthesizer, and the like, in order to realize, for example, at least one of frequency division duplexing (FDD) and time division duplexing (TDD). For example, the transmitting unit 1010 of the transmitting device 1000 and the receiving unit 1110 and the transmitting unit 1130 of the receiving device 1100 described above may also be realized by the communication apparatus 1404.

The input apparatus 1405 is an input device that accepts input from outside (e.g., a keyboard, a mouse, a microphone, a switch, a button, a sensor, etc.). The output apparatus 1406 is an output device that implements the output to the outside (e.g., a display, a speaker, an LED light, etc.). Additionally, the input apparatus 1405 and the output apparatus 1006 may form an integrated structure (e.g., a touch panel).

In addition, the respective apparatuses such as the processor 1401, the memory 1402, and the like are connected via a bus 1407 for communicating information. The bus 1407 may be constituted using either a single bus or different buses for each apparatus.

In addition, the transmitting device 1000 and the receiving device 1100 may also include a microprocessor, a digital signal processor (DSP), an ASIC (Application Specific Integrated Circuit), a PLD (Programmable Logic Device), a FPGA (Field Programmable Gate Array), and other hardware, through which part or all of each functional block is realized. For example, the processor 1001 may be realized using at least one of these hardware.

### Variation Example

Furthermore, in the present disclosure, the notification of the information is not limited to the manner/implementation illustrated in the present disclosure, but may also be carried out using other methods. For example, the notification of information may also be performed through a physical layer signaling (e.g., DCI (Downlink Control Information), UCI (Uplink Control Information)), high-layer signaling (e.g., RRC (Radio Resource Control) signaling, MAC (Medium Access Control) signaling, broadcast information (MIB (Master Information Block), SIB (System Information Block))), or other signals, or a combination of these. In addition, the RRC signaling may also be referred to as an RRC message, e.g., which may also be an RRC Connection Setup message, an RRC Connection Reconfiguration message, etc.

The respective solutions/implementations described in this disclosure may also be applied to at least one of LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x e.g. being integer, decimal)), FRA (Future Radio Access), NR (new Radio), new radio access (NX), Future generation radio access (FX), W-CDMA (registered trademark), GSM (registered trademark), CDMA2000, UMB (Ultra Mobile Broadband), IEEE 802.11 (Wi-Fi (Registered Trademark)), IEEE 802.16 (WiMAX (Registered Trademark)), IEEE 802.20, UWB (Ultra-WideBand), Bluetooth (Registered Trademark), systems utilizing other appropriate systems, and next generation systems that are extended, modified, made, or specified based on them. In addition, the plurality of systems may also be applied in combination (e.g., at least one of LTE and LTE-A in combination with 5G, etc.).

The processes, timings, flowcharts, and the like of the methods/implementations described in this disclosure may be reversed as long as there is no contradiction. For example, for the methods illustrated in the present disclosure, elements of a wide variety of steps are suggested using an exemplary order, without being limited to the particular order suggested.

Specific operations set forth in the present disclosure as being performed by a base station are sometimes performed by an upper node thereof, depending on the circumstances. In a network constituted by one or more network nodes comprising a base station, it is clear that a wide variety of operations for communication with a terminal can be performed by at least one of the base station and other network nodes other than the base station (e.g., consider, but not limited to, an MME or an S-GW, etc.). In the above, a case in which the network node other than the base station is one is exemplified, but a combination of a plurality of other network nodes (e.g., MME and S-GW) is also possible.

Information, etc. (*Refer to the item “Information, Signal”) can be output from a high layer (upper layer) (or a low layer (lower layer)) to a low layer (or a high layer). It can also be input and output through multiple network nodes.

The input and output information and so on may be stored in a specific part (e.g., memory) or managed using a management table. The input and output information and so on can be overwritten, updated, or added. The output information and so on may also be deleted. The input information and so on may also be transmitted to other apparatuses.

Judgment may be performed either by a value (0 or 1) represented by 1 bit, by a true or false value (Boolean: true or false), or by comparison of values (e.g., comparison with a specific value).

The various ways/implementations illustrated in this disclosure may be used either individually or in combination, or may be switched along with the execution. In addition, notification of specific information (e.g., notification of “is X”) is not limited to being performed explicitly, but may also be performed implicitly (e.g., notification of the specific information is not performed).

The above description of the present disclosure has been provided in detail, but it is apparent to a person skilled in the art that the present disclosure is not limited to the embodiments described in the present disclosure. Without departing from the subject and scope of the present invention determined by the claims, the present disclosure is capable of being implemented as an amendment as well as a change mode. Therefore, the present disclosure is described for the purpose of exemplary illustration, and there is no restrictive meaning to the present disclosure.

In the present disclosure, whether software is referred to as software, firmware, middleware, microcode, hardware description language, or by any other name, it should be broadly construed to mean instructions, instruction sets, code, code segments, program code, programs, subroutines, software modules, applications, software applications, software packages, routines, subroutines, objects, executables, threads of execution, processes, functions, and the like.

In addition, software, instructions, information, etc. may be transmitted and received via a transmission medium. For example, where at least one of wired technology (coaxial cable, fiber optic cable, twisted pair cable, DSL (Digital Subscriber Line), etc.) and wireless technology (infrared, microwave, etc.) is used to send the software from a website, server, or other remote source, at least one of these wired and wireless technologies is included in the definition of the transmission medium.

The information, signals, etc. illustrated in this disclosure may also be represented using one of a wide variety of different technologies. For example, data, instructions, commands, information, signals, bits, symbols, chips, and the like, which may be referred to throughout the foregoing description, may also be represented by a voltage, an electric current, an electromagnetic wave, a magnetic field or magnetic particles, an optical field or photons, or any combination thereof.

In addition, terms described in the present disclosure and those necessary for an understanding of the present disclosure may be substituted for terms having the same or similar meanings. For example, at least one of a channel and a symbol may also be a signal (signaling). In addition, a signal may also be a message. In addition, a component carrier (CC) may also be referred to as a carrier frequency, a cell, a frequency carrier, and the like.

The terms “system” and “network” used in this disclosure are used interchangeably.

In addition, the information, parameters, and the like described in the present disclosure may be expressed in absolute values, relative values with respect to a particular value, or other corresponding information. For example, a wireless resource may also be indicated by an index.

The names used for the parameters described above are not limiting names in all respects. Further, the mathematical formulas, etc., in which these parameters are used are sometimes different from those explicitly disclosed in the present disclosure. Various channels (e.g., PUCCH, PDCCH, etc.) as well as information elements can be identified by any suitable name, and thus the various names assigned to these various channels as well as information elements are not limiting names in all respects.

In the present disclosure, “Base Station (BS)”, “wireless base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and other terms can be used interchangeably. The base station is also sometimes referred to using terms such as a macro cell, a small cell, a femtocell, and a picocell.

A base station can accommodate one or more (e.g., three) cells. In the case of a base station accommodating multiple cells, the overall coverage area of the base station can be divided into several smaller areas, and each of these smaller areas can be served by a base station subsystem (e.g., a small base station for indoor use (RRH: Remote Radio Head)). A term such as “cell” or “sector” refers to a portion or the whole of the coverage area of at least one of the base station and base station subsystem in which communication services are provided in the coverage.

In the present disclosure, “MS (Mobile Station)”, “user terminal”, “UE (User Equipment)”, “terminal”, and other terms can be used interchangeably.

A mobile station is also sometimes referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a hand-held talker, a subscriber agent, a mobile client, a client, or a couple of other appropriate terms.

At least one of the base station and the mobile station may also be referred to as a transmitting apparatus, a receiving apparatus, a communication apparatus, and the like. In addition, at least one of the base station and the mobile station may be a device that is mounted on a mobile body, a mobile body, and the like. The mobile body is an object capable of moving at an arbitrary speed. It is also possible that the mobile body is stopped. The mobile body includes, for example, a vehicle, a delivery vehicle, a car, a two-wheeled motorcycle, a bicycle, a connected car, a forklift, a bulldozer, a wheel loader, a dump truck, a forklift, a train, a bus, a rear trailer, a rickshaw, a ship and other watercraft, an airplane, a rocket, an artificial satellite, an drone (registered trademark), a multirotor, a quad-rotor (vertical take-off and landing) quadcopter, a balloon, and objects being carried on them, or is not limited thereto. In addition, the mobile body may also be a mobile body that travels autonomously based on an operational command. It can be either a vehicle (e.g., a car, an airplane, etc.), a mobile body that moves in an unmanned manner (e.g., a drone, an autonomous vehicle, etc.), or a robot (manned or unmanned). In addition, at least one of the base station and the mobile station also includes an apparatus that does not necessarily move during the communication operation. For example, at least one of the base station and the mobile station may also be an IoT (Internet of Things) device such as a sensor.

In addition, the base station in the present disclosure may also be interpreted as a user terminal. For example, it is also possible to apply the various modes/implementations of the present disclosure with respect to a structure in which the communication between the base station and the user terminal is replaced with the communication between a plurality of user terminals (e.g., this may also be referred to as D2D (Device-to-Device), V2X (Vehicle-to-Everything), etc.). In this case, it is also possible to set a structure in which the user terminal 20 has the functions that the base station 10 has as described above. In addition, terms such as “uplink” and “downlink” and so on may be replaced with terms (e.g., “side”) corresponding to inter-terminal communication. For example, an uplink channel, a downlink channel, and the like may be replaced with a side channel.

Similarly, a user terminal in this disclosure may be interpreted as a base station. In that case, it may also be set a structure in which the base station 10 has the functions that the user terminal 20 has as described above.

The term “determining” as used in the present disclosure sometimes encompasses a wide variety of operations. For example, “determining” may encompass considering judging, calculating, computing, processing, deriving, investigating, looking up, searching, inquiring (e.g., searching in tables, databases, or other data structures), and ascertaining as having made a “determination”. In addition, “determining” may include considering receiving (e.g., receiving information), transmitting (e.g., transmitting information), inputting, outputting, accessing (e.g., accessing data in memory) as having made a “judgment”, “decision” and so on. In addition, “judgment” and “decision” may include considering resolving, selecting, choosing, establishing, comparing, etc. as having made a “judgment” and “decision” and so on. That is to say, “judgment” and “decision” may include treating certain operations as having made a “judgment” and “decision” and so on. In addition, “judgment (decision)” may also be replaced by “assuming”, “expecting”, “considering”, and the like.

In the present disclosure, terms such as “connected”, “coupled”, or all variations thereof, imply that all connections or combinations, whether direct or indirect, between two or more elements, can include the case of the presence of one or more intermediate elements between two elements that are “connected” or “coupled” to each other. The joint or connection between the elements may be physical, logical or a combination thereof. For example, “connection” may be replaced with “access”. As used in the present disclosure, it can be contemplated that at least one of one or more wires, cables, and printed electrical connections, and as some non-limiting and non-inclusive examples, wavelengths having a wireless frequency domain, a microwave domain, and an optical (both visible and invisible) domain, are used.

The expression “based on” as used in this disclosure does not mean “based on only” as long as it is not explicitly stated otherwise. In other words, “based on” means both “based only on” and “based on at least”.

Any reference to elements using the designations “first”, “second”, etc., as used in the present disclosure is not intended to be a comprehensive limitation on the amount or order of those elements. These designations can be used in the present disclosure as a convenient method of distinguishing between two or more elements. Thus, references to the first and second elements do not imply that only two elements can be employed, or that the first element must take precedence over the second element in some way.

In the present disclosure, it is also possible to replace “unit” in the structure of each of the above-described apparatuses with “circuit”, “device”, etc.

In the present disclosure, when the terms “include” and “including” and their variations are used, these terms are used in the same way as the term “comprising” for being inclusive. Further, the term “or” as used in the present disclosure implies that it is not exclusive OR.

The present disclosure is described in detail above, but it will be apparent to those skilled in the art that the present disclosure is not limited to the embodiments described herein. The present disclosure may be implemented as a modification and a change in the manner of implementation without departing from the purpose and scope of the present disclosure as defined by the claims. Accordingly, the present specification is recorded for the purpose of exemplary illustration and is not intended to have any limiting significance with respect to the present disclosure.

1. A transmitting device comprising:
a transmitting unit comprising a first antenna array; and
a control unit configured to determine a second projection array of a receiving antenna array of a receiving device in a second affine subspace of the receiving device, to determine a first projection array of the second projection array in a first affine subspace of the transmitting device, and to determine a transmitting subarray in the first antenna array according to information about an angle of departure of a signal of the transmitting device and the first projection array.

2. The transmitting device as claimed in claim 1, wherein
the control unit determines the second projection array of the receiving antenna array of the receiving device in the second affine subspace of the receiving device according to information about an angle of arrival of a signal at a receiving device and information about a pose of a receiving device.

3. The transmitting device as claimed in claim 1, wherein
the control unit is further configured to determine the second projection array according to information about a number and spacing of antennas in the receiving array.

4. The transmitting device as claimed in claim 1, wherein
the control unit determines the first projection array of the second projection array in the first affine subspace of the transmitting device according to information about a distance between the receiving device and the transmitting device.

5. A method for determining a transmitting subarray, applied to a transmitting device, the transmitting device comprising a first antenna array, the method comprising:
determining a second projection array of a receiving antenna array of a receiving device in a second affine subspace of the receiving device according to information about a pose of the receiving device;
determining a first projection array of the second projection array in a first affine subspace of the transmitting device; and
determining a transmitting subarray in the first antenna array according to information about a pose of the transmitting device and the first projection array.

6. A receiving device comprising:
a receiving unit comprising a receiving antenna array;
a control unit configured to determine a second projection array of a receiving antenna array in a second affine subspace of a receiving device according to information about an angle of arrival of a signal at the receiving device and information about a pose of the receiving device; and
a transmitting unit configured to transmit information about the second projection array.
